(19) United States
(12) Patent Application Publication
(10) Pub. No.: US 2026/0336984 A1
(43) Pub. Date: Oct. 29, 2026

(54) MOVING WALKWAY COMPRISING A CLEANING DEVICE

(71) Applicant: INVENTIO AG, Hergiswil (CH)

(72) Inventors: Jeff Zhang, Shanghai (CN); Mark Ma, Shanghai (CN)

(21) Appl. No.: 19/106,082

(22) PCT Filed: Sep. 4, 2023
(86) PCT No.: PCT/EP2023/074109

§ 371 Date: Feb. 24, 2025

(30) Foreign Application Priority Data
Sep. 20, 2022 (EP) 22196452.1

(51) Int. Cl. B66B 31/00

(52) U.S. Cl. CPC B66B 31/003

(57) ABSTRACT

The invention relates to a moving walkway which has a supporting structure and a pallet belt which is guided in the supporting structure with guide rails and arranged to be circumferentially movable. The pallet belt comprises two ring-shaped, closed conveyor chains and pallets arranged between them which interconnect the two conveyor chains. Each of the pallets has a tread surface, wherein the pallet belt has a forward run that can be accessed by users and a return run that is hidden from users. Each of the conveyor chains has at least one brush arrangement with a brush arranged in a positionally fixed manner in the supporting structure. The brush is in contact with those lateral edge regions of the tread surfaces which are adjacent to the conveyor chain associated with this brush.

### TECHNICAL FIELD

The present disclosure relates to a moving walkway which can comprise a supporting structure and a pallet belt arranged in the supporting structure so as to be circumferentially movable.

### SUMMARY

Moving walkways of the aforementioned type are well-known and efficient apparatuses for transporting persons. They are typically used for transporting persons horizontally or on a slight incline of up to 12° from one location in a building to another location in the building. The pallet belt used to transport users is guided by means of guide rails arranged in the supporting structure and has two ring-shaped, closed conveyor chains and pallets arranged between them that interconnect the two conveyor chains. Each of the pallets comprises a tread surface, wherein the pallet belt, due to its circumferentially movable arrangement, has a forward run that can be accessed by users and a return run that is hidden from users.

To keep energy losses and operating noise low, the conveyor chains must be lubricated. Excess lubricating oil is collected in oil collection channels that extend parallel to the conveyor chains and are arranged below each conveyor chain with respect to the intended operating position of the pallet belt. However, due to the specific design of the moving walkway (the pallets are returned with the tread surface facing downwards during the return run), the continuous lubrication of the conveyor chain inevitably results in the lubricating oil flowing to the tread surface visible in the forward run during the moving walkway's operation. This makes the pallet belt very unsightly and implies poor maintenance to the user. In addition, the lubricating oil can disfigure expensive footwear or luggage, or lubricating oil sticking to soles can result in accidents due to slipping on slippery floors adjacent to the moving walkways.

From WO2010/121331A1, a cleaning device for cleaning tread surfaces is known. Since there is no space in moving walkways to install such cleaning devices, the cleaning device is periodically installed in the forward run by maintenance personnel, and the brush thereof mechanically cleans the entire tread surface. However, the moving walkway cannot be used during this time, and periodic installation and removal is time-consuming and expensive. In addition, due to periodic use, it is not possible to reliably prevent lubricating oil from spreading on the tread surfaces.

From JP H11 217177 A, a brush arrangement for an escalator is known, which arrangement serves to clean contrastingly colored edge regions of the tread surfaces.

JP H0873172 A discloses a device for removing lubricating oil adhering to step shafts of an escalator. For this purpose, each of the step shafts has a drip ring on each side, on which the lubricating oil collects and is scraped off by a fixed brush.

The object of the present disclosure is to propose a cleaning device which can be produced and used cost-effectively, and which can reliably prevent the distribution of lubricating oil on the tread surfaces.

This object can be achieved by a moving walkway which, for each of the conveyor chains of its pallet belt, can comprise at least one brush arrangement having one brush. This brush arrangement can be arranged in a positionally fixed manner in the supporting structure with respect to the intended operating position of the pallet belt in the return run and below the conveyor chain. Each of these brushes can be in contact with the lateral edge regions of the tread surfaces. The lateral edge regions can be strip-shaped partial surfaces of the tread surface that are adjacent to the conveyor chains. Furthermore, the brush arrangement can comprise a receiving element with at least one guide element, wherein the brush may be fastened to the receiving element. The guide element can direct lubricating oil, reaching the receiving element, in a predetermined direction.

In other words, the entire tread surface may not be covered by the bristles of the brush arrangement, but, rather, a lateral edge region of the tread surface that is adjacent to each conveyor chain. Extensive tests have confirmed that the arrangement of the brush in the lateral edge region is excellent in effectively preventing the lubricating oil film from spreading over the tread surface. On the one hand, this can be because accumulations of lubricating oil can be continuously removed from the edge region and, on the other hand, can be because lubricating oil adhering to the bristles of the brush may not be taken up by adjacent bristles and applied to dry locations of the tread surface. In addition, due to their small dimensions, the brush arrangements can be easily accommodated in the return run on both sides of the pallet belt, so that they may be in continuous and not just periodic use. Furthermore, driving operations may not be affected in any way. Since lubricating oil film may not spread, dirt and dust adhere much less to the tread surfaces, so that they may fall off the tread surface due to gravity during the return run. This can also minimize the cleaning effort for the entire tread surface. At this point, it should be noted that the terms “brush and bristles” should not be considered as limiting the disclosure. Instead of a brush with synthetic and/or metal bristles, resilient scrapers, sponge-like blocks of material, absorbent pads, bundled wick material, and the like can also be used to remove lubricating oil from the lateral edge regions of the pallets. The guide element can prevent the removed lubricating oil from spreading uncontrollably to other components within the moving walkway and can instead direct it to a location within the moving walkway where lubricating oil and dirt may collect anyway.

In one embodiment, the brush arrangement can comprise a holder, the first end of which can be firmly connected to the supporting structure and to the second end of which the receiving element can be fastened to the brush. In addition, the holder can comprise a telescopic apparatus which can be arranged between the first end and the second end. The distance between the brush and the tread surfaces of the pallet belt can be adjusted using the telescopic apparatus. This can give the brush arrangement greater flexibility in terms of selecting suitable fastening locations in the supporting structure, and the bristle pressure of the brush on the tread surface can be continuously adjusted. In addition, the wear of the bristles can be compensated for by periodically adjusting the telescopic apparatus.

The telescopic apparatus can be realized, for example, by a screw connection that is arranged between two components of the holder. In this case, in one of the two components, at least one slot-shaped hole can be formed through which a screw of the screw connection can protrude in the assembled state.

In a further embodiment, at least one slot-shaped fastening hole can be formed at the first end of the holder, in which at least one fastening screw that can be connected to the supporting structure can be arranged to protrude. This may allow the position of the holder relative to the supporting structure to be adjusted within a region specified by the slot-shaped fastening hole. Preferably, the slot-shaped hole of the telescopic apparatus can extend in a plane which is arranged orthogonally to the plane in which the slot-shaped fastening hole may extend.

Preferably, the receiving element in the moving walkway can be arranged in the predetermined installation position thereof inclined towards an oil collection channel of the moving walkway. This can assist in the drainage of lubricating oil scraped off the brush into the oil collection channel, so that small amounts of lubricating oil remain on the brush.

In a further embodiment, the brush arrangement can comprise a clamping device with which the brush can be detachably connected to the receiving element. This means that a worn-out brush can be removed and a new brush can be installed in just a few steps.

To lubricate the conveyor chain, the moving walkway can comprise at least one lubricant dispensing device for each conveyor chain. Preferably, the lubricant dispensing device can be arranged in a positionally fixed manner in the supporting structure in the return run above the conveyor chain and can dispense the lubricating oil to the conveyor chain via bristles. Due to gravity, the lubricating oil can flow to the lower edge of the conveyor chain, wherein excess lubricating oil can form drops at the lower edge and can drip into the oil collection channel. To ensure that the lubricating oil drops forming on the lower edge do not become too large and then spread over the tread surfaces, the brush arrangement associated with the conveyor chain can preferably be arranged in the region of the lubricant dispensing device. The conveyor chain can thus be passed between the lubricant dispensing device and the brush arrangement. “In the region” does not necessarily mean that the brush of the brush arrangement must be arranged exactly vertically below the lubricant dispensing device. The brush arrangement can also be arranged with an offset in the running direction of the conveyor chain, wherein the length of the offset can be adapted to the flow rate (viscosity) of the lubricating oil, to the distance to be covered (height of the conveyor chain), and to the conveying speed of the conveyor chain. Of course, a moving walkway can also have more than one brush arrangement per conveyor chain.

### BRIEF DESCRIPTION OF THE DRAWINGS

Embodiments of the disclosure will be described herein with reference to the accompanying drawings, wherein neither the drawings nor the description are intended to be interpreted as limiting the disclosure. Identical or equivalent features have the same reference signs. In the drawings:

FIG. 1 is a schematic, partial cross-section of a moving walkway with a pallet belt with pallets that can be moved circumferentially and guided by guide rails, wherein a brush arrangement is provided for cleaning edge regions of the pallets;

FIG. 2 is an enlarged view of the section A shown in FIG. 1;

FIG. 3 is a three-dimensional view of the brush arrangement shown in FIGS. 1 and 2.

The figures are merely schematic and not true-to-scale. In the various figures, identical reference signs denote identical or similar features.

### DETAILED DESCRIPTION

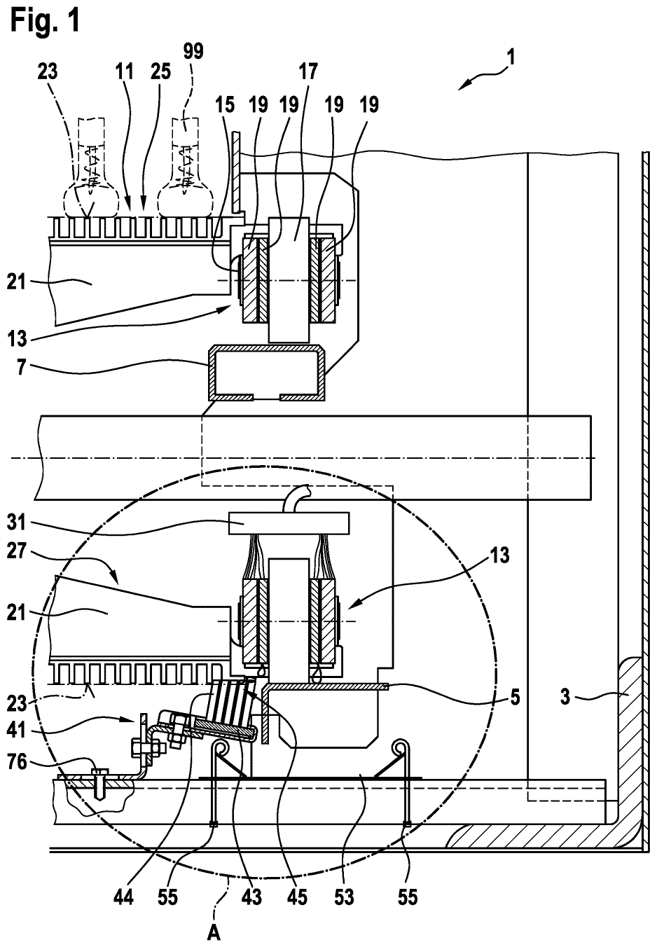

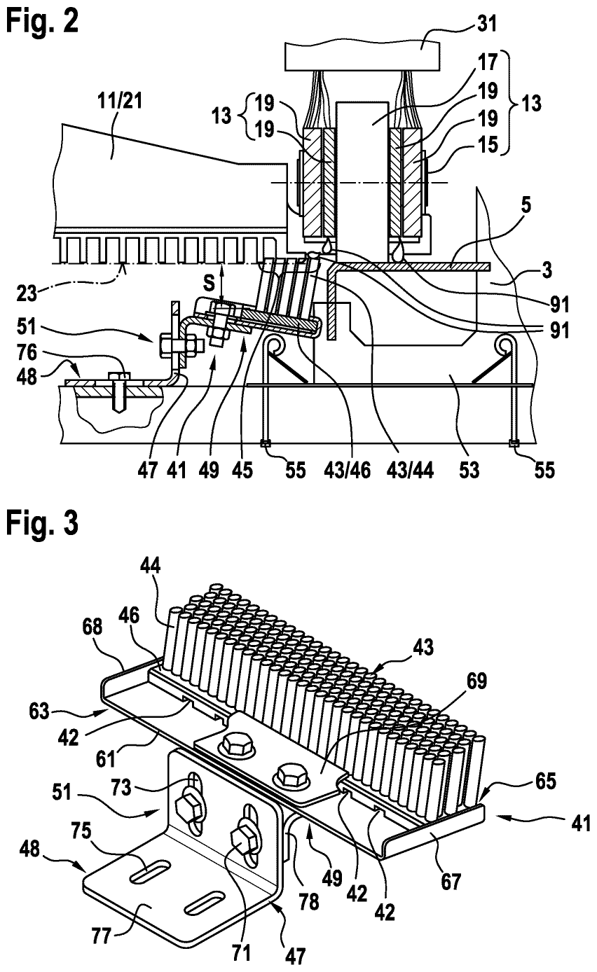

FIG. 1 is a schematic, partial cross-section of a moving walkway 1. In its basic structure, this corresponds to known moving walkway structures, which is why the partial cross-section only shows just under a quarter of the actual cross-section of the moving walkway 1. FIG. 2 is an enlarged view of the section A indicated in FIG. 1, which is why the two figures are described together below.

The moving walkway 1 has a supporting structure 3 in which guide rails 5, 7 are mounted. The guide rails 5, 7 may guide a pallet belt 11 which is arranged in the supporting structure 3 so as to be circumferentially movable. Said belt has two ring-shaped, closed conveyor chains 13 (only one of the two conveyor chains 13 is shown because of the partial cross-section), which are arranged parallel to one another and spaced apart from one another in the supporting structure 3. The conveyor chains 13 are link chains that can be made of steel, on the chain joint pins 15 of which rollers 17 are also rotatably mounted. The rollers 17 can run on the guide rails 5, 7 and can support the pallet belt 11 thereon. In the present exemplary embodiment, the rollers 17 are arranged between the chain links 19 of the conveyor chain 13. However, conveyor chains 13 can also be used in which the rollers 17 are arranged laterally of the chain links 19.

Furthermore, the pallet belt 11 has a plurality of pallets 21 arranged one behind the other, which are arranged between the conveyor chains 13 and interconnect the two conveyor chains 13. Each of the pallets 21 comprises a tread surface 23. Due to its circumferentially movable arrangement, the pallet belt 11 has a forward run 25 that can be accessed by users 99 and a return run 27 that can be hidden from users 99.

For each of the conveyor chains 13, at least one lubricant dispensing device 31 that can be configured for lubricating the conveyor chain 13 is present in the moving walkway 1. The lubricant dispensing device 31 can be fastened in the supporting structure 3 in the return run 27 of the pallet belt 11 and, with respect to the intended operating position of the pallet belt 11, above the conveyor chain 13.

The moving walkway 1 also has for each of the conveyor chains 13 at least one brush arrangement 41 with a brush 43. The brush arrangement 41 is arranged in a positionally fixed manner in the supporting structure 3 with respect to the intended operating position of the pallet belt 11 in the return run 27, and below the conveyor chain 13. In this case, the brush 43 is in contact with those lateral edge regions 45 of the tread surfaces 23 which are adjacent to the conveyor chain 13 associated with this brush 43. For example, on both sides of a pallet 21, a three-centimeter-wide strip of the tread surface 23 is brushed over by bristles 44 of the brush 43. Since the accumulating lubricating oil 91 (see in particular FIG. 2) in these edge regions 45 can be continuously removed by the brush arrangement 41, it may not spread to the remaining tread surface 23.

The brush arrangement 41 is arranged in the region of the lubricant dispensing device 31, wherein the conveyor chain 13 can be passed between the lubricant dispensing device 31 and the brush arrangement 41. The brush arrangement 41 comprises a holder 47, the first end 48 of which is firmly connected to the supporting structure 3 and to the second end 49 of which the brush 43 can be fastened. The holder 47 has a telescopic apparatus 51 which is arranged between the first end 48 and the second end 49. With the telescopic apparatus 51, a distance S between the brush 43 and the tread surfaces 23 of the pallet belt 11 can be set.

Strictly speaking, the distance S between a brush body 46 of the brush 43 and the tread surface 23 may be adjusted, since the bristles 44 of the brush 43 should have a predefined contact pressure and thus, theoretically, a predefined overlap (indicated accordingly in FIG. 2). In fact, the bristles 44 may not protrude into the body of the pallets 21, but may bend out according to the direction of movement of the pallet belt 11.

Below the conveyor chain 13 and partly also below the brush arrangement 41, an oil collection channel 53 is arranged, which can extend in the return run 27 parallel to the longitudinal direction of the conveyor chain 13. The oil collection channel 53 can be made of thin sheet metal and can be held in a positionally fixed manner in the supporting structure 3 by spring clips 55.

In FIG. 3, which shows the brush arrangement 41 shown in FIGS. 1 and 2 in a three-dimensional view, further details of the same can be seen. At the second end 49 of the holder 47, a receiving element 61 for the brush 43 is arranged. In its intended installation position, the receiving element 61 may be inclined towards the oil collection channel 53 of the moving walkway 1 (see also FIGS. 1 and 2) in order to support the drainage of the lubricating oil 91 that may be wiped off by the brush 43 into the oil collection channel 53. Due to this arrangement, the receiving element 61 has a higher edge 63 and a lower edge 65 with respect to its installation position. The brush 43 can have flow channels 42 in its brush body 46 so that the lubricating oil 91 can flow even better from the direction of the higher edge 63 to the lower edge 65 of the receiving element 61 and can drip there into the oil collection channel 53. The receiving element 61 also has guide elements 67, 68 which can guide the lubricating oil 91 in a predetermined direction towards the lower edge 65 of the receiving element 61.

Furthermore, the brush arrangement 43 has a clamping device 69, with which the brush 43 or its brush body 46 is detachably connected to the receiving element 61. This means that a brush 43 with worn bristles 44 can easily be replaced with a new brush 43 during maintenance work.

The telescopic apparatus 51 mentioned herein can be formed by a screw connection 71 which is arranged between two components 77, 78 of the holder 47. For this purpose, in one of the two components 77, at least one slot-shaped hole 73 can be formed through which a screw of the screw connection 71 may protrude in the assembled state.

Furthermore, at least one slot-shaped fastening hole 75 can be formed at the first end 48 of the holder 47, in which at least one fastening screw 76 (see FIGS. 1 and 2) that can be connected to the supporting structure 3 is arranged to protrude. As a result, the position of the holder 43 relative to the supporting structure 3 can be adjusted within a region specified by the slot-shaped fastening hole 75. In order to be able to adjust the position of the brush 43 relative to the pallet 21 in at least two dimensions of the three-dimensional space, the slot-shaped hole 73 of the telescopic apparatus 51 can extend in a plane which is arranged orthogonally to the plane in which the slot-shaped fastening hole 75 extends. The width of the edge region 45 can be varied through the slot-shaped fastening hole 75, as can be seen in FIG. 2.

Furthermore, the brush arrangement 41 can also be arranged with an offset in the running direction of the conveyor chain 13 (in FIGS. 1 and 2, said conveyor chain runs orthogonally to the plane of the drawing), wherein the length of the offset can be adapted to the flow rate (viscosity) of the lubricating oil, to the distance to be covered (height of the conveyor chain 13), and to the conveying speed of the conveyor chain 13. If the moving walkway 1 is designed for two running directions, there may, for example, be two brush arrangements 41 per conveyor chain 13, which are arranged with a corresponding offset with respect to the two running directions of the conveyor chain 13, before and after the lubricant dispensing device 31.

Although only screw connections 71, 76 and slot-shaped holes 73, 75 are shown in FIG. 1 to 3, it should be appreciated that, for the present disclosure, further holder structures that can be fixed in defined positions, such as blockable linear guides, rod frames with lockable joint nodes, and the like, can be used to adjust the correct position of the brush 43 in relation to the tread surfaces 23 of the pallets 21. Of course, rigid holders 47 can also be used, which have no adjustment options at all. Furthermore, for each conveyor chain 13, there may be more than one brush arrangement 41 which are arranged one behind the other along the guide rails 5, 7. In addition, instead of brushes 43 with synthetic and/or metal bristles 44, resilient scrapers, sponge-like blocks of material, absorbent pads, bundled wick material, and the like can also be used to remove lubricating oil 91 from the lateral edge regions 45 (usually two per pallet 21) of the pallets 21.

Finally, it should be noted that terms such as “having,” “comprising,” etc., do not preclude other elements or steps, and terms such as “a” or “one” do not preclude a plurality. Reference signs in the claims should not be considered to be limiting.

1-8. (canceled)

9. A moving walkway comprising:
a supporting structure; and
a pallet belt arranged in the supporting structure configured to move circumferentially around at least one guide element arranged in the supporting structure, the pallet belt comprising:
a forward run configured for users to access;
a return run that is arranged such that it is hidden from the users;
two ring-shaped closed conveyor chains;
a plurality of pallets, each pallet of the plurality of pallets comprising a tread surface arranged between the two ring-shaped closed conveyor chains configured to interconnect the two ring-shaped closed conveyor chains;
at least one brush arrangement comprising a brush, the at least one brush arrangement arranged in a positionally fixed manner in the supporting structure with respect to an operating position of the pallet belt in the return run and below the two ring-shaped conveyor chains,
wherein the brush is arranged in contact with lateral edge regions of the tread surfaces arranged adjacent to the ring-shaped closed conveyor chain of the two ringed-shaped closed conveyor chains corresponding to the brush, and wherein the at least one brush arrangement comprises a receiving element comprising at least one of the at least one guide element, and wherein the brush is fastened to the receiving element, and wherein the at least one guide element directs lubricating oil entering the receiving element in a predetermined direction.

10. The moving walkway of claim 9, wherein the at least one brush arrangement further comprises a holder comprising a first end and a second end, wherein the first end is firmly connected to the supporting structure, and wherein the second end comprises the receiving element and wherein the brush is fastened to the receiving element, and wherein the holder comprises a telescopic apparatus between the first end and the second end configured to adjust a distance between the brush and the tread surfaces of the plurality of pallets.

11. The moving walkway of claim 10, wherein the telescopic apparatus is formed by a screw connection between a first component and a second component of the holder, wherein, at least one slot-shaped hole is formed through the first component which a screw of the screw connection protrudes in an assembled state.

12. The moving walkway of claim 10, wherein at least one slot-shaped fastening hole is formed at the first end of the holder, in which at least one fastening screw is protruding through arranged to connect the holder to the supporting structure such that a position of the holder relative to the supporting structure is adjustable within a region specified by the at least one slot-shaped fastening hole.

13. The moving walkway of claim 11, wherein at least one slot-shaped fastening hole is formed at the first end of the holder, in which at least one fastening screw is protruding through arranged to connect the holder to the supporting structure such that a position of the holder relative to the supporting structure is adjustable within a region specified by the at least one slot-shaped fastening hole.

14. The moving walkway of claim 9, wherein the receiving element is arranged in the moving walkway inclined towards an oil collection channel of the moving walkway.

15. The moving walkway of claim 10, wherein the receiving element is arranged in the moving walkway inclined towards an oil collection channel of the moving walkway.

16. The moving walkway of claim 11, wherein the receiving element is arranged in the moving walkway inclined towards an oil collection channel of the moving walkway.

17. The moving walkway of claim 12, wherein the receiving element is arranged in the moving walkway inclined towards an oil collection channel of the moving walkway.

18. The moving walkway of claim 9, wherein the at least one brush arrangement comprises a clamping device configured to detachably couple the brush to the receiving element.

19. The moving walkway of claim 10, wherein the at least one brush arrangement comprises a clamping device configured to detachably couple the brush to the receiving element.

20. The moving walkway of claim 11, wherein the at least one brush arrangement comprises a clamping device configured to detachably couple the brush to the receiving element.

21. The moving walkway of claim 12, wherein the at least one brush arrangement comprises a clamping device configured to detachably couple the brush to the receiving element.

22. The moving walkway of claim 9, wherein each of the two ring-shaped closed conveyor chains comprises at least one lubricant dispensing device configured to lubricate the corresponding ring-shaped closed conveyor chain of the two ring-shaped closed conveyor chains, wherein the at least one lubricant dispensing device is arranged positionally fixed above the corresponding ring-shaped closed conveyor chain of the two ring-shaped closed conveyor chains.

23. The moving walkway of claim 10, wherein each of the two ring-shaped closed conveyor chains comprises at least one lubricant dispensing device configured to lubricate the corresponding ring-shaped closed conveyor chain of the two ring-shaped closed conveyor chains, wherein the at least one lubricant dispensing device is arranged positionally fixed above the corresponding ring-shaped closed conveyor chain of the two ring-shaped closed conveyor chains.

24. The moving walkway of claim 11, wherein each of the two ring-shaped closed conveyor chains comprises at least one lubricant dispensing device configured to lubricate the corresponding ring-shaped closed conveyor chain of the two ring-shaped closed conveyor chains, wherein the at least one lubricant dispensing device is arranged positionally fixed above the corresponding ring-shaped closed conveyor chain of the two ring-shaped closed conveyor chains.

25. The moving walkway of claim 12, wherein each of the two ring-shaped closed conveyor chains comprises at least one lubricant dispensing device configured to lubricate the corresponding ring-shaped closed conveyor chain of the two ring-shaped closed conveyor chains, wherein the at least one lubricant dispensing device is arranged positionally fixed above the corresponding ring-shaped closed conveyor chain of the two ring-shaped closed conveyor chains.

26. The moving walkway of claim 22, wherein each of the at least one brush arrangement is arranged in a region of at least one of the at least one lubricant dispensing device, and each of the two ring-shaped closed conveyor chains is passed between the at least one lubricant dispensing device and the corresponding at least one brush arrangement.

27. The moving walkway of claim 23, wherein each of the at least one brush arrangement is arranged in a region of at least one of the at least one lubricant dispensing device, and each of the two ring-shaped closed conveyor chains is passed between the at least one lubricant dispensing device and the corresponding at least one brush arrangement.

28. The moving walkway of claim 24, wherein each of the at least one brush arrangement is arranged in a region of at least one of the at least one lubricant dispensing device, and each of the two ring-shaped closed conveyor chains is passed between the at least one lubricant dispensing device and the corresponding at least one brush arrangement.
